(19) United States
(12) Patent Application Publication
(10) Pub. No.: US 2008/0157575 A1
(43) Pub. Date: Jul. 3, 2008

(54) Upholstery Element And Production Process

(76) Inventor: Michael Janz, Huellhorst (DE)

Correspondence Address: DICKINSON WRIGHT PLLC, 1901 L. STREET NW, SUITE 800, WASHINGTON, DC, 20036, US

(21) Appl. No.: 11/910,483

(22) PCT Filed: Mar. 24, 2006
(86) PCT No.: PCT/EP2006/002718

§ 371 Date: Oct. 2, 2007

(30) Foreign Application Priority Data
Apr. 4, 2005 (DE) 10 2005 015 473.5

(51) Int. Cl. A47C 27/00; B32B 37/10

(52) U.S. Cl. 297/218.1; 156/60

(57) ABSTRACT

An upholstery element (21) for a seat, in particular of a motor vehicle, comprises fibres that are bonded by means of a binder to form an air-permeable moulding and a sheet-like spacer component (18), which is arranged on the seating surface side of the moulding. The fibres and the spacer component (18) are directly bonded to each other by the binder. The upholstery element (21) can be produced by the sheet-like spacer component (18) being placed in the cavity of an opened mould (2), scattered with the fibres, sprayed with the binder and subsequently compressed by closing the mould (2).

### CROSS REFERENCE TO RELATED APPLICATIONS

None

### BACKGROUND OF THE INVENTION

1. Field of the Invention

The invention relates to an upholstery element, for example a backrest or a seat part, for a seat, in particular of a motor vehicle, consisting of fibers which are bonded by means of a binder to form a preferably air-permeable molding and a sheet-like spacer component which is arranged on the seating surface side of the molding, as well as a process for the production thereof.

2. Related Art

A generic upholstery element is known from practice. Thus in the publication ABB connect, edition 03/2003, a process for producing an upholstery element consisting of fibers and latex is disclosed in which a robot provided with a special mixing head scatters a first layer made up of fibers and latex into a die. Subsequently, by means of aluminum forming jaws, said robot stamps out the head geometry and side cheeks of the backrest of a vehicle seat and scatters over the hollow spaces again. The subsequently closed die forms the complete geometry.

Generally, before the scattering, a fine non-woven material is placed into the die which prevents an adhering of the latex to the surface of the die. For drying the sprayable emulsion made up of water and latex, air is subsequently blown through the molding. The upholstery element produced in this manner, consisting of a composite of fibers arranged in an entangled and loose manner, is moved into an autoclave for vulcanization of the latex and may subsequently be provided with a spacer fabric on the non-woven material side by adhesive lamination.

Such upholstery elements are used for high quality vehicle seats which are passively or actively air-conditioned and fulfill the highest requirements in seating comfort. Moreover, said upholstery parts may be easily recycled. The production time thus depends to a considerable extent on the time required for drying the emulsion.

A process for producing a molding consisting of natural fiber material mixed with a binder is disclosed in the publication DE 195 08 167 C2, in which an aqueous binder is compressed with the fibers in a mold to form a molding and subsequently dried and vulcanized outside the mold. An additional spacer component is not provided with said molding.

### SUMMARY OF THE INVENTION

The object of the invention is to rationalize the production of such high value upholstery elements.

In a generic upholstery element, the object is achieved by the fibers and the spacer component being bonded to one another directly by the binder. On the one hand, the aforementioned non-woven material is consequently dispensed with, as contact between the binder and the die surface is avoided. On the other hand, the air blown into the die between the die surface and the fiber element, for drying, is distributed in the spacer component parallel to the surface and thus also reaches remote and awkward corner regions of the upholstery body. As a result, the drying time required before removing the molding may be considerably reduced. Moreover, manual lamination of the spacer component is eliminated by using an adhesive.

The sheet-like spacer component may be configured as a spacer fabric i.e. from a sheet-like structure produced from wound filamentous semi-finished products which has a relatively large open cross-sectional component between its surface sides which are spaced apart from one another, but allows a force transmission between the surface sides. A suitable spacer fabric is, for example, known from the publication DE 199 03 070 A1, the entire disclosure of which is hereby incorporated by reference.

An advantageous spacer fabric, in the non-compressed state, has a thickness of 5 to 15 mm, preferably approximately 10 mm. For the use according to the invention, the free cross section of such a spacer fabric allows a sufficient airflow parallel to the surface sides.

The binder preferably contains natural or synthetic latex which may be applied in liquid form. The fibers are preferably at least partially of natural origin and consist advantageously at least partially of coir, flax or animal bristles. The length of the fibers may be 5 to 15 cm, preferably 7.5 to 12.5 cm, in particular approximately 10 cm.

In a process for producing such an upholstery element, the sheet-like spacer component is placed in the cavity of an open die and scattered with the fibers. Subsequently, the binder is sprayed on. By closing the die, the bond is subsequently compressed. The fibers already cut to their final measurement may be provided in the form of a twisted strand and separated by counterdirectional winding of the strand before scattering into the die. An additional cutting process is thus not required. In principle, it is naturally also possible to select a different delivery state (balls or the like).

The fibers and/or binder are automatically supplied to the die, which may be accomplished by means of a robot.

After closing the die, for drying the binder, air is blown into the filled cavity, which is distributed over the spacer component in the upholstery element and produces a uniform drying process. To shorten the drying time further, it may be provided that the air is dried and/or heated before being blown in.

### BRIEF DESCRIPTION OF THE DRAWINGS

The figures show schematically and by way of example different embodiments of the invention, in which:

FIG. 1 shows the construction of an installation suitable for carrying out the process according to the invention,

FIGS. 2a-d show the process sequence in the production of the upholstery element.

### DETAILED DESCRIPTION OF THE PREFERRED EMBODIMENT

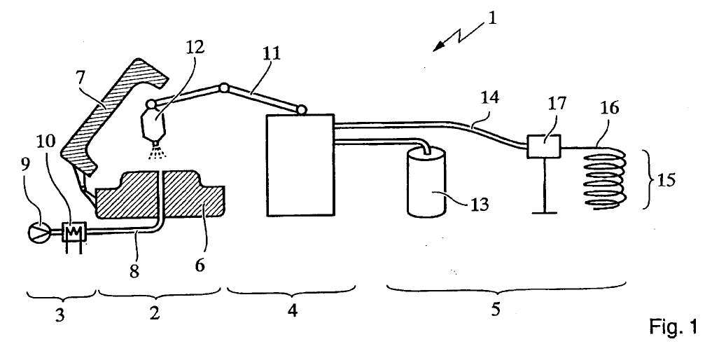

The production installation shown in FIG. 1 comprises a die 2, an air generator 3, a robot 4 and a device 5 for providing fibers and binders. The die 2 is constructed in two parts in the embodiment and comprises a lower die 6 as well as an upper die 7 which may be lifted away therefrom. In the closed state, the upper and lower die (6, 7) form a cavity of complex shape. An air duct 8 opens into said cavity from the lower die 6 and which is connected to the air generator 3. The air generator 3 comprises a fan 9 and a downstream device 10 for drying and heating the air. In this manner, drying air may be blown into the cavity of the closed die, which again escapes over the parting plane between the lower and upper die (6, 7).

The robot 4 is provided with an arm 11 which bears a spraying tool 12 which is movable in a plurality of axes, and is suitable for moving said spraying tool, when the die 2 is open, over the lower die 6 and thus spraying all regions of the cavity associated with the lower die 6. On the one hand, an emulsion containing a binder is supplied from a container 13 to the spraying tool 12 and finite fibers are further supplied via a pipe 14. The fibers which have already been cut to length are delivered to a reel 15 in the form of a twisted strand 16 and separated in a device 17 connected to the pipe 14 by counterdirectional winding of the strand 16 into individual fibers. In the spray head 12, the binder and fibers are introduced at the same time into the lower die 6 by means of compressed air.

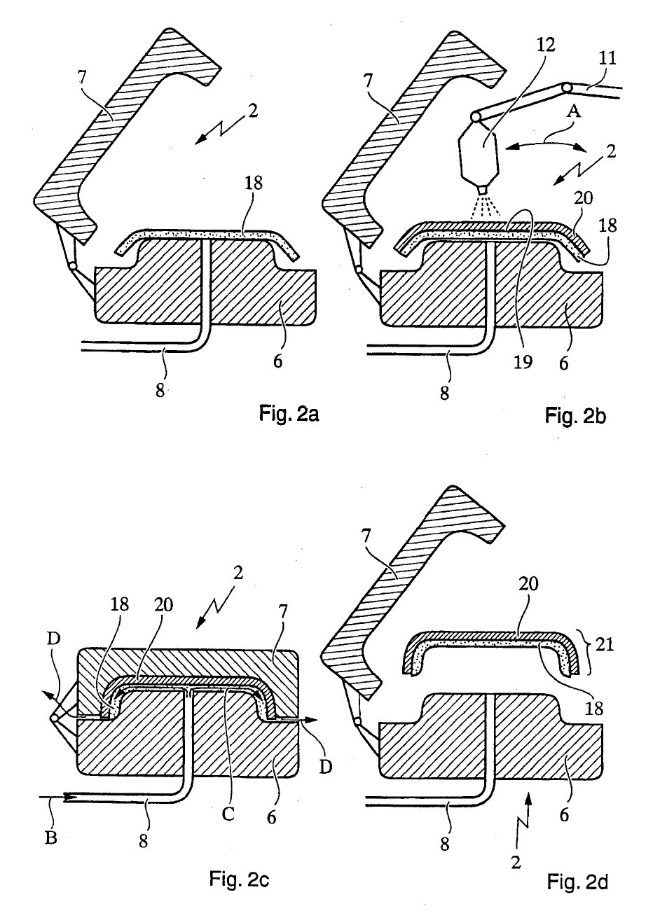

As is visible from FIGS. 2a to 2d, when carrying out the process, firstly a blank of the sheet-like spacer component 18 is positioned on the lower die 6. This process may be carried out manually or automatically (FIG. 2a). Subsequently, as shown in FIG. 2b, by means of the spray head 12 the emulsion containing the binder as well as the fibers are applied to the spacer component 18 such that on the surface thereof 19 a relatively thick, entangled layer 20 of fibers wetted with binder is formed. The pivoting movements of the spray head 12 are indicated by the arrow A. By closing the die (FIG. 2b) the spacer component 18 and the layer 20 are compressed to form a complex molding (FIG. 2c). Sliders, not shown, in the die 2 may additionally reshape or compress regions of the molding in a specific manner.

The drying air supplied via the air duct 8 in the lower die 6 (arrow B) may be distributed in the spacer component 18 parallel to the surface sides thereof (indicated by arrow B) and escape outwardly in the region of the separation between the lower and upper die (6, 7) as well as through ventilation bores, not shown, in the upper die 7 (indicated by arrow D). In this connection, so much water is removed from the sprayed emulsion by the drying air that the layer 20 dries to form an elastic, but dimensionally stable molding, which is connected to the spacer component 18 by the binder, without further measures. The entangled fibers are thus spaced apart from one another such that the layer 20 is also air-permeable, even when the flow resistance thereof (when the flow is viewed parallel to the surface side) is markedly greater than inside the spacer component 18. As shown in FIG. 2d, the upholstery element 21 thus produced may be removed after opening the die 2. The final curing of the binder (vulcanization of the latex) takes place subsequently in special ovens.

The upholstery element 21 produced according to the invention is specifically suitable for use in air-conditioned seats, in particular as a support on foam upholstery of motor vehicle seats, the spacer component 18 allowing a uniform distribution of the air flow.

The foregoing invention has been described in accordance with the relevant legal standards, thus the description is exemplary rather than limiting in nature. Variations and modifications to the disclosed embodiment may become apparent to those skilled in the art and fall in the scope of the invention. Accordingly the scope of legal protection afforded this invention can only be determined by studying the following claims.

### REFERENCE NUMERALS

1 Production plant

2 Die

3 Air generator

4 Robot

5 Device (for providing fibers and binder)

6 Lower die

7 Upper die

8 Air duct

9 Fan

10 Device (drying and heating the air)

11 Arm

12 Spraying tool

13 Container

14 Pipe

15 Reel

16 Strand

17 Device (for separating the fibers)

18 Spacer component

19 Surface (of the spacer component)

20 Layer (made up of entangled, wetted fibers)

21 Upholstery element

1. An upholstery element (21) for a seat of the type used in a motor vehicle, said upholstery element comprising:
a plurality of fibers which are bonded by means of a binder to form an air-permeable molding,
a sheet-like spacer component (18) arranged on the seating surface side of the molding,
and characterized in that the fibers and the spacer component (18) are directly bonded to one another by the binder.

2. The upholstery element as claimed in claim 1, further characterized in that the sheet-like spacer component (18) is configured as spacer fabric.

3. The upholstery element as claimed in claim 1, further characterized in that the spacer component (18) in the non-compressed state has a thickness of 5 to 15 mm.

4. The upholstery element as claimed in claim 1, further characterized in that the binder contains latex which may be applied in liquid form.

5. The upholstery element as claimed in claim 1, further characterized in that the fibers are at least partially of natural origin.

6. The upholstery element as claimed in claim 5, further characterized in that the fibers include at least partially coir, flax or animal bristles.

7. The upholstery element as claimed in claim 1, further characterized in that the fibers have a length of 5 to 15 cm.

8. A method for producing an upholstery element for a vehicular seat, said method comprising the steps of:
providing an openable die cavity (2);
providing a plurality of fibers;
providing a binder;
providing a sheet-like spacer component;
and characterized in that the sheet-like spacer component (18) is placed in the cavity of an open die (2), scattered with the fibers, sprayed with the binder and subsequently compressed by closing the die.

9. The process as claimed in claim 8, further characterized in that the fibers provided in the form of a twisted strand (16) are separated by counterdirectional winding of the strand (16) before scattering into the die (2).

10. The process as claimed in claim 8, further characterized in that at least one of the fibers and binder are automatically supplied to the die (2) by means of a robot (4).

11. The process as claimed in claim 8, further characterized in that after closing the die (2), for drying the binder, air is blown into the filled cavity.

12. The process as claimed in claim 11, further characterized in that the air is dried and/or heated before being blown in.
